(19) United States
(12) Patent Application Publication
(10) Pub. No.: US 2008/0278091 A1
(43) Pub. Date: Nov. 13, 2008

(54) Method and Circuit for Driving Back a Light Emitter of a Display Apparatus

(75) Inventors: Arnold Willem Buij, Eindhoven (NL); Geert Willem Van Der Veen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,932

(22) PCT Filed: Jun. 29, 2005
(86) PCT No.: PCT/IB2005/052163

§ 371 Date: Dec. 19, 2006

(30) Foreign Application Priority Data
Jul. 2, 2004 (EP) 04103142.8

(51) Int. Cl. H05B 41/16

(52) U.S. Cl. 315/246

(57) ABSTRACT

A back light emitter (4) of a display apparatus is supplied with alternating current (AC) bursts. An emitted light representing signal is generated from the AC bursts as supplied to the light emitter (4). The emitted light representing signal is compared with a reference signal REF to provide an error signal. A duration of the AC bursts is adjusted dependent on the error signal, such as to minimize the error signal.

### FIELD OF THE INVENTION

The invention relates to a method for driving a back light emitter of a display apparatus, a circuit applying said method and an apparatus comprising such circuit according to the preambles of claim 1, 5 and 9 respectively. In particular the light emitter is a fluorescent lamp and more in particular the display apparatus comprises several adjacent fluorescent lamps arranged at the back of a display panel of such an apparatus.

### BACKGROUND OF THE INVENTION

A method, a circuit and an apparatus of the above type are known from practice. Usually each lamp is driven by its own driver circuit. Both such driver circuits and the lamps may have different characteristics. Since the human perception of light is sensitive for differences rather than absolute amounts of light energies emitted by such lamps, both the drivers and the lamps must be matched as much as possible to have the lamps emit the same amounts of light energy for identical drive signals. It is difficult to meet the tight specifications of components which are necessary for preventing unwanted perception of different light outputs from different lamps at reasonable costs. It will be even more difficult with AC bursts becoming shorter. This is, for example, the case when the lamps are driven sequentially, that is, in a so-called scanning mode, which is presently applied for liquid crystal display television applications.

### OBJECT OF THE INVENTION

It is an object of the invention to solve the drawbacks of the above method and circuit of the types described.

### SUMMARY OF THE INVENTION

The above object of the invention is achieved by providing a method as described in claim 1.

With said method the amplitude of AC bursts passing through the lamp are of no concern, provided that they are sufficient to provide the light energies wanted during periods of time which may be adjusted according to the method.

The method can be implemented by hardware and/or software, the choice of which may be dependent from frequencies of signals of concern.

The above object of the invention is also achieved by providing a circuit as described in claim 5.

The above object of the invention is also achieved by providing a display apparatus as described in claim 9.

### BRIEF DESCRIPTION OF THE DRAWINGS

The invention will become more gradually apparent from the following exemplary description in connection with the accompanying drawings. In the drawings:

FIG. 1 shows a diagram of a first embodiment of a circuit for driving a back light emitter according to the invention;

FIG. 2 shows a time diagram for illustrating the operation of the circuit shown in FIG. 1;

FIG. 3 shows a diagram of a second embodiment a circuit for driving a back light emitter according to the invention; and

FIG. 4 shows a diagram of a third embodiment a circuit for driving a back light emitter according to the invention.

### DETAILED DESCRIPTION OF EMBODIMENTS

A today's display apparatus usually comprises a flat screen device, such as a selectively light translucent liquid crystal display (LCD), which is driven by control circuitry of the apparatus.

FIG. 1 shows diagrammatically a part of circuitry of a display apparatus in which the invention is applied.

The diagram shown in FIG. 1 comprises a selectively light translucent display panel 2. At the back of panel 2 a plurality of light emitters 4 are arranged. In particular, the light emitters 4 are fluorescent tube lamps. Dependent on select signals from a select circuit (not shown) supplied to panel 2 picture elements (pixels) of panel 2 are made translucent or opaque.

As is knows from practice, a light emitter 4 can be driven continuously or discontinuously. In the latter case alternating current (AC) bursts having a high frequency, such as 50 kHz are generated by an AC pulse generator, such as generator 6 shown in FIG. 1, which AC bursts are then boosted by a driver circuit, such as driver 8 shown in FIG. 1, and which boosted AC bursts are then supplied to a specific light emitter 4. With the prior art different light emitters 4 may share a single AC pulse generator 6 but they are driven by separate drivers 8 respectively.

An AC pulse has typically an on-time of 3 ms and an off-time between two succeeding bursts of about 10 ms. The average light output of a light emitter 4 is dependent on the amplitude of a current through the lamp and of the duration of the AC bursts. Since characteristics of different light emitters 4 and different drivers 8 may be different and may alter in time, it is virtually impossible to obtain and maintain uniform light outputs from different light emitters 4 when using identical AC bursts from an AC burst generator.

According to the invention the prior art circuit comprising an AC pulse generator 6, a driver 8 for driving a light emitter 4 only, is improved by the addition of a control loop, by which at least one entity representing the light being emitted by a light emitter 4 is sensed, the entity is then compared to a reference for providing an error signal, and the error signal is used to adjust the loop such as to minimize said error in time.

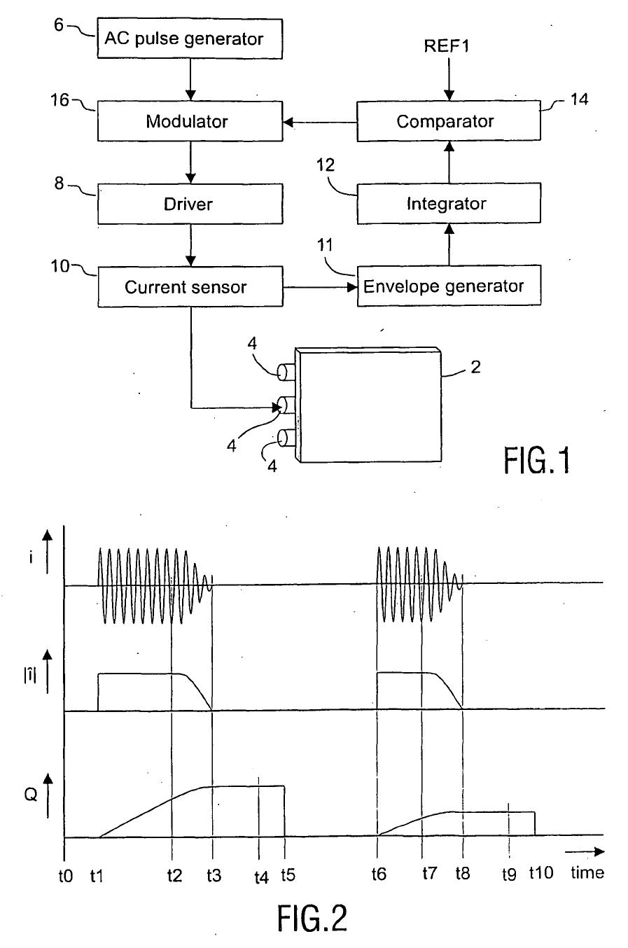

Therefore, according to the invention, for each light emitter 4 a current sensor 10 is arranged in series with the driver 8 and the light emitter 4. Current sensor 10 senses a current i flowing through the light emitter 4. The top line of FIG. 2 shows an example of said current i in time. In particular FIG. 2 shows two AC bursts, of which the difference will be explained later.

The inventors conceived that the amount of light emitted during the on-time of a light emitter 4 is determined by the amount of electrical charge that is passed through the light emitter 4 in the first place. It was found that a very good estimation of said amount of electrical charge can be obtained by creating an envelope signal from said current i. Accordingly, the circuit comprises an envelope generator 11 for generating such envelop signal |î|, of which the center line of FIG. 2 shows an example.

The envelope signal |î| is integrated by an integrator 12. Since the envelope signal |î| has some an amplitude and a duration dependent on the current i flowing through the light emitter 4 and since it is integrated in time, the integrated envelope signal provides a representation of the amount of electrical charge Q passed through the lamp and thus provides a representation of the amount of light emitted by the light emitter 4. At the bottom line of FIG. 2 there is shown an example of said amount of electrical charge Q.

A comparator 14 compares the emitted light representing signal Q and a reference signal REF1 to therewith provide an error signal.

The error signal is supplied to a modulator 16 which is arranged in series between the AC pulse generator 6 and the current sensor 10, such as between the AC pulse generator 6 and the driver 8.

Modulator 16 modulates the duration of the AC bursts which it receives from the AC generator 6 dependent on the error signal supplied by comparator 14. Modulator 16 is arranged to vary the duration of the AC bursts to minimize said error signal.

For the purpose of varying the duration of AC bursts, modulator 16 will take a sample from the error signal after termination of an AC burst, for example at a time t4 shown in FIG. 2, and will then bold the sample. Then the modulator 16 will vary the duration of a next AC burst (or bursts) dependent on the sample. Before starting integrating again the former integration operation is reset, as represented at a time t5.

Making and maintaining accurate time settings is difficult, in particular in cases where the plurality of light emitters 4 are not energized at the same time, but alternating the one after the other. This type of operation of light emitters, called scanning mode operation, is known from television applications for avoiding a smeared perception by a watcher.

At sampling times t4 and t9 the integration value Q is larger and smaller than the other respectively. Supposing that a value of the reference signal REF lies between said values of Q, modulator 16 will decrease the duration of a next AC burst after taking a sample of the larger integration value Q at t4.

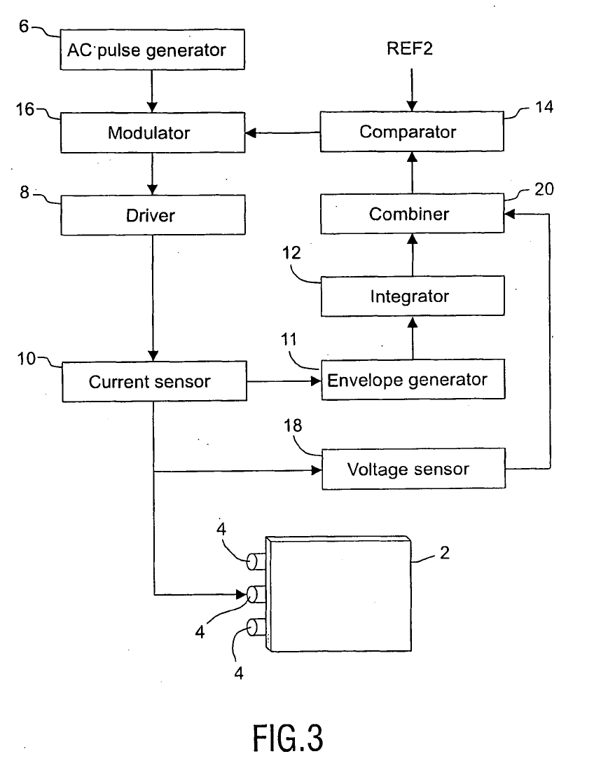

The diagram of the second embodiment of the circuit according to the invention shown in FIG. 3 differs from the diagram shown in FIG. 1 by the addition of a voltage sensor 18, which is connected to the light emitter 4, and a combiner 20, which is arranged in series with the integrator 12 and the comparator 14. The voltage sensor 18 is arranged to sense a voltage at or across the light emitter 4. Voltage sensor 18 supplies a measured voltage signal to the combiner 20. The combiner 20 processes the integration value Q and a flattened version of the measured voltage signal to provide a signal which represents the electrical power supplied to the light emitter 4 at that time. The combiner 20 may comprise a simple multiplier and a scaling member for scaling the output of the combiner 20 such that the remainder of the diagram can be maintained identical to the diagram shown in FIG. 1.

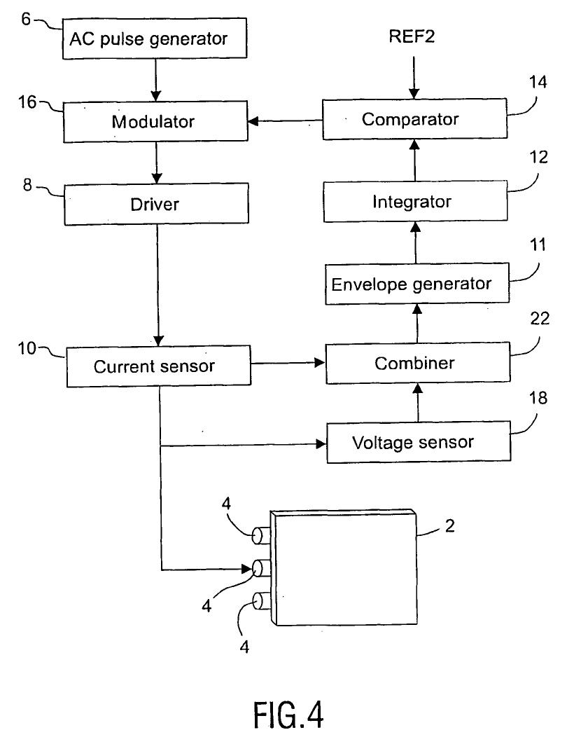

The diagram of the second embodiment of the circuit according to the invention shown in FIG. 4 differs from the diagram shown in FIG. 3 by that the measured current signal and the measured voltage signal are first combined, in particular multiplied, by the combiner 22 and de result thereof is supplied to the comparator 14 via the envelope detector 11 and the integrator 12.

In both cases as illustrated by FIGS. 3 and 4 and using an appropriate reference signal REF2 the true lamp power can be controlled.

The reference signal REF may be fixed or may be varied. In the latter case it can be used to dim the emission of light by all or a specific one of the light emitters 4 on demand from some control circuit.

Dependent on the frequencies, duration of on-time, duration of off-time of AC bursts, the accuracy required for modulating the AC bursts, specifications and costs of analogue/digital circuits and other circuits any combination of the components 10-18 of the circuit according to the invention can be implemented by hardware only or by hardware which operates by the use of software.

1. A method for driving a back light emitter of a display apparatus in which the light emitter is supplied with alternating current (AC) bursts, characterized by a control sequence during which:
a) a current flowing to the light emitter is measured to provide a measured current signal,
b) an envelope signal is generated dependent on the measured current signal,
c) the envelope signal is integrated to provide an integrated envelope signal,
d) an emitted light representing signal is provided dependent on the integrated envelope signal,
e) the emitted light representing signal is compared with a reference signal to provide an error signal, and
f) a setting of a duration of AC bursts is adjusted dependent on the error signal, such as to minimize the error signal.

2. Method according to claim 1, characterized by the measuring of a voltage at the light emitter to provide a measured voltage signal, and in that the emitted light representing signal is determined from a combination of the measured current signal and the measured voltage signal to represent a value of the power of the light emitter.

3. Method according to a preceding claim, characterized in that, the control sequence spans one or more AC burst cycles and the integrated envelope signal is reset before the control sequence is started again.

4. Method according to a preceding claim, characterized in that, one or a combination of the generation of the envelope signal, integrating the envelope signal, the determination of the emitted light representing signal, the comparing of the emitted light representing signal and the reference signal, and the adjusting of a setting of a duration of AC bursts is implemented by software.

5. Circuit for driving a back light emitter of a display apparatus in which the light emitter is supplied with alternating current (AC) bursts from an AC burst generator, characterized by:
a) a current detector, which measures a current flowing through the light emitter to therewith provide a measured current signal,
b) an envelope generator, which detects an envelope of the measured current signal to therewith provide an envelope signal, which is dependent on the measured current signal,
c) an integrator, which integrates the envelope signal to therewith provide an integrated envelope signal,
d) a member, which provides an emitted light representing signal dependent on the integrated envelope signal,
e) a comparator, which compares the emitted light representing signal and a reference signal to therewith provide an error signal,
d) a modulator, which is arranged to receive AC bursts, to modulate the duration of the AC bursts dependent on the error signal, and to supply the modulated AC bursts to the light emitter, such as to minimize the error signal.

6. Circuit according to claim 5, characterized by a voltage detector, which measures a voltage at the light emitter to provide a measured voltage signal, and a processor which determines the emitted light representing signal from a combination of the measured current signal and the measured voltage signal to represent a value of the power of the light emitter.

7. Circuit according to claim 5 or 6, characterized in that, the integrator integrates the envelope signal during one or more AC burst cycles and the integrator resets the integrated envelope signal before integrating the envelope signal again.

8. Circuit according to claim 5, 6 or 7, characterized in that, one or a combination of the envelope generator, the integrator, the processor, the comparator, and the modulator is implemented by software.

9. Display apparatus, comprising a display panel, at least one back light emitter which is arranged at the back of the display panel, and an alternating current (AC) burst generator for supplying the light emitter with AC bursts, characterized by a circuit for driving the back light emitter according any of the claims 5 to 8.
